(19) United States
(12) Patent Application Publication
(10) Pub. No.: US 2011/0099161 A1
(43) Pub. Date: Apr. 28, 2011

(54) DIGITAL CONTENT REPRODUCTION APPARATUS

(75) Inventor: Shigeki Ito, Daito City (JP)

(73) Assignee: SANYO ELECTRIC CO., LTD., Moriguchi City (JP)

(21) Appl. No.: 12/907,528

(22) Filed: Oct. 19, 2010

(30) Foreign Application Priority Data
Oct. 22, 2009 (JP) 2009-243771

(51) Int. Cl. G06F 17/30

(52) U.S. Cl. 707/722; 707/769; 707/E17.014

(57) ABSTRACT

Provided is a digital content reproduction apparatus, which has an Internet connection function, including a search condition input section, a search execution section, and a display signal generation section. The search condition input section receives an input of a search condition. The search execution section executes a search according to the search condition input through the search condition input section by setting digital content provided by a plurality of Internet video providing services as a search target. The display signal generation section generates a display signal for collectively displaying results of the search executed by the search execution section in a list.

This nonprovisional application claims priority under 35 U.S.C. §119(a) on Patent Application No. 2009-243771 filed in Japan on Oct. 22, 2009, the entire contents of which are hereby incorporated by reference.

### BACKGROUND OF THE INVENTION

1. Field of the Invention

The present invention relates to a digital content reproduction apparatus which has an Internet connection function and can reproduce digital content acquired via the Internet.

2. Description of Related Art

In recent years, there have been increasing digital television sets, which have not only a function of receiving and displaying a television broadcast, but also have a function of reproducing and displaying the digital content including a moving image and a still image acquired via the Internet instead of the television broadcast. Further, a large number of set-top boxes (STB), an object of which is only to acquire/reproduce the digital content acquired from the Internet, are available on the market.

The digital content that can be acquired via the Internet (hereinafter, referred to also as “Internet content”) includes innumerable items of content of different kinds such as: content whose copyright is held by a motion picture company, a broadcast station, a content production company, or the like and which is provided for a price; content whose copyright is held by a motion picture company, a broadcast station, a content production company or the like but which is provided for free for the purpose of promotion or by inserting an advertisement or the like; and content called “user generated content (UGC)” generated by users which is provided for free.

Further, fee charging systems for providing the Internet content include: a system that allows unlimited views of all the content items provided by a service at a flat rate fee; and a pay-per-view (PPV) system in which a fee is charged for each content item. Further, in the PPV system, different fees may be charged on the same content item according to a difference in resolution between an HD image quality and an SD image quality.

As described above, there are innumerable options available in a case of viewing the Internet content. Therefore, the options for the content viewed by a user explosively expand by introducing a digital content reproduction apparatus that can reproduce the Internet content. In addition, if the digital content reproduction apparatus has a television broadcast receiving function, content items obtained from digital terrestrial broadcasts provided for free, fee-based cable television broadcasts, and the like are also included in the options for the content viewed by the user.

A conventional fee-based channel program selection guide apparatus displays a fee-based channel program selection guide table that lists fee-based broadcast programs, and hence a user who attempts to view a fee-based broadcast program can obtain information indicating which broadcast program is more expensive/cheaper than another fee-based program, which produces an effect that a viewing fee can be invested effectively.

However, unlike programs on television broadcasts that are standardized strictly, the Internet content is provided in various formats and is not managed in a unified manner. In order to realize limited access to the Internet, dedicated application software for access to an Internet video providing service is generally built into the digital content reproduction apparatus for each Internet video providing service in advance, and the dedicated application software for access to an Internet video providing service is used to acquire the Internet content.

The access to an Internet video providing service from the digital content reproduction apparatus is thus made through the dedicated application software, and hence digital content provided by another Internet video providing service cannot be referenced by the conventional digital content reproduction apparatus. That is, the conventional digital content reproduction apparatus may have a function of searching for digital content within application software of each Internet video providing service, but cannot simultaneously compare digital content across a plurality of Internet video providing services.

Therefore, in a case where the same digital content is provided by different Internet video providing services, there is a fear that the digital content provided by the Internet video providing service on worse conditions may be selected on the conventional digital content reproduction apparatus. Further, it is also feared that a program of the same contents as the content purchased for a price through the Internet video providing service may be digitally broadcast for free in the near future.

### SUMMARY OF THE INVENTION

An object of the present invention is to provide a digital content reproduction apparatus capable of aiding a user to rationally select digital content that the user wishes to view.

In order to attain the above-mentioned object, according to the present invention, there is provided a digital content reproduction apparatus, which has an Internet connection function, including a search condition input section, a search execution section, and a display signal generation section. The search condition input section receives an input of a search condition. The search execution section executes a search according to the search condition input through the search condition input section by setting digital content provided by a plurality of Internet video providing services as a search target. The display signal generation section generates a display signal for collectively displaying results of the search executed by the search execution section in a list.

### BRIEF DESCRIPTION OF THE DRAWINGS

FIG. 1 is a diagram illustrating a hardware configuration example of a digital television receiver according to an embodiment of the present invention.

FIG. 2 is a diagram illustrating a software configuration example of the digital television receiver according to the embodiment of the present invention.

FIG. 3 is a flowchart illustrating an operation regarding a search for digital content.

FIG. 4 is a diagram illustrating an example of a menu screen for a content search.

FIG. 5 is a diagram illustrating an example of a search result list screen.

### DETAILED DESCRIPTION OF PREFERRED EMBODIMENT

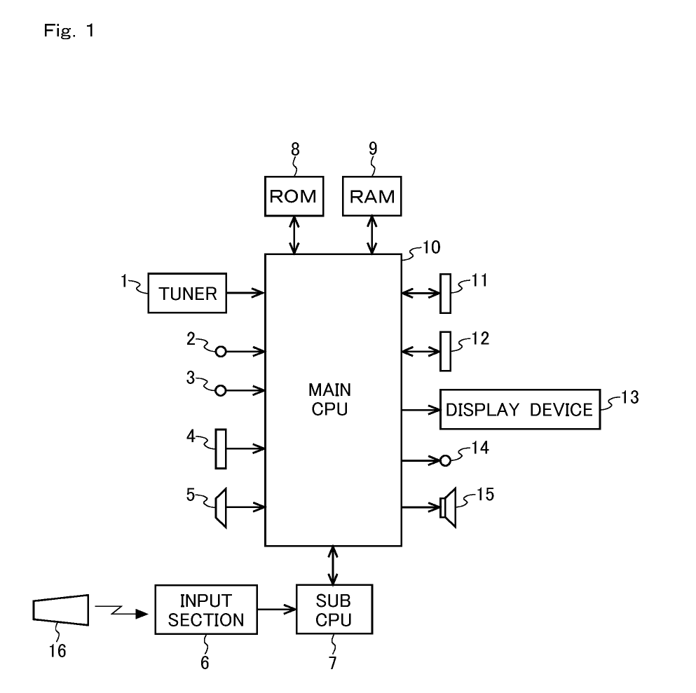

An embodiment of the present invention is described below with reference to the accompanying drawings. Here, the description is made by taking a digital television receiver as an example of a digital content reproduction apparatus according to the present invention. FIG. 1 illustrates a schematic configuration example of the digital television receiver according to the embodiment of the present invention.

FIG. 1 illustrates a hardware configuration example of the digital television receiver according to the embodiment of the present invention. The digital television receiver according to the embodiment of the present invention illustrated in FIG. 1 includes a tuner 1, a video input terminal 2, an audio input terminal 3, an HDMI input terminal 4, a VGA input terminal 5, an input section 6, a sub CPU 7, a ROM 8 for storing a control program, setting data, and the like, a RAM 9 used as a work memory, a main CPU 10, a USB terminal 11, an Ethernet (registered trademark) terminal 12, a display device 13, a picture output terminal 14, and a speaker 15.

The tuner 1 receives an input of television broadcast waves such as a terrestrial television broadcast and a cable television broadcast, and downconverts a television broadcast wave of a selected channel in an RF signal format into an IF signal having a specific frequency. Further, the tuner 1 demodulates the IF signal, generates a transport stream, and outputs the generated transport stream to the main CPU 10. The main CPU 10 analyzes the transport stream received from the tuner 1, generates a video signal and an audio signal from analysis results thereof, and outputs the generated video signal to the display device 13 or the picture output terminal 14 and the generated audio signal to the speaker 15. By such an operation, the digital television receiver according to the embodiment of the present invention illustrated in FIG. 1 reproduces digital content provided through the television broadcast waves.

The Ethernet (registered trademark) terminal 12 that is a terminal for connection to the Internet receives an input of digital content that can be acquired via the Internet. The digital content input to the Ethernet (registered trademark) terminal 12 is subjected to a data processing by the main CPU 10. After that, the video signal obtained as a result of the data processing is output to the display device 13 or the picture output terminal 14, and the audio signal obtained as a result of the data processing is output to the speaker 15. By such an operation, the digital television receiver according to the embodiment of the present invention illustrated in FIG. 1 reproduces the digital content that can be acquired via the Internet.

The video input terminal 2 receives an input of the video signal output from an external device to which the video input terminal 2 is connected. The audio input terminal 3 receives an input of the audio signal output from an external device to which the audio input terminal 3 is connected. Further, the HDMI input terminal 4 receives an input of a digital video signal output from an HDMI source apparatus to which the HDMI input terminal 4 is connected. Further, the VGA input terminal 5 receives an input of an analog video signal output from an external device to which the VGA input terminal 5 is connected. The digital television receiver according to the embodiment of the present invention illustrated in FIG. 1 is controlled by the main CPU 10 to perform the display on the display device 13, the external output of a picture from the picture output terminal 14, and the audio output from the speaker 15 based on the signals input to those terminals.

Further, the main CPU 10 performs data communications with a USB device to which the USB terminal 11 is connected. The digital television receiver according to the embodiment of the present invention illustrated in FIG. 1 is controlled by the main CPU 10 to perform the display on the display device 13, the external output of a picture from the picture output terminal 14, and the audio output from the speaker 15 based on the data input to the USB terminal 11.

A remote control 16 is a transmitter for sending an instruction to the digital television receiver according to the embodiment of the present invention illustrated in FIG. 1. When a key (not shown) provided to the remote control 16 is operated by a user, a remote control signal corresponding to the operated key is sent out from a light emitting section (not shown) of the remote control 16.

The input section 6 includes a remote control signal receiving section (not shown) for receiving light of the remote control signal, converting the light into an electrical signal, and supplying the electrical signal to the sub CPU 7. Further, the input section 6 further includes operation buttons (not shown) provided to a front surface, a side surface, and the like of the digital television receiver according to the embodiment of the present invention illustrated in FIG. 1.

The sub CPU 7 performs a processing on the electrical signal output from the remote control signal receiving section (not shown) of the input section 6 and the signal output from the input section 6 when the user operates the operation button (not shown) of the input section 6. Note that, even if a power-off operation (transition to a power save mode) is performed by the remote control 16, the sub CPU 7 operates by receiving power supply and performs a processing for monitoring the remote control signal and other such processings. The sub CPU 7 and the main CPU 10 are designed to communicate with each other, and the sub CPU 7 controls the main CPU 10 to stop/start and decides operation contents of the main CPU 10.

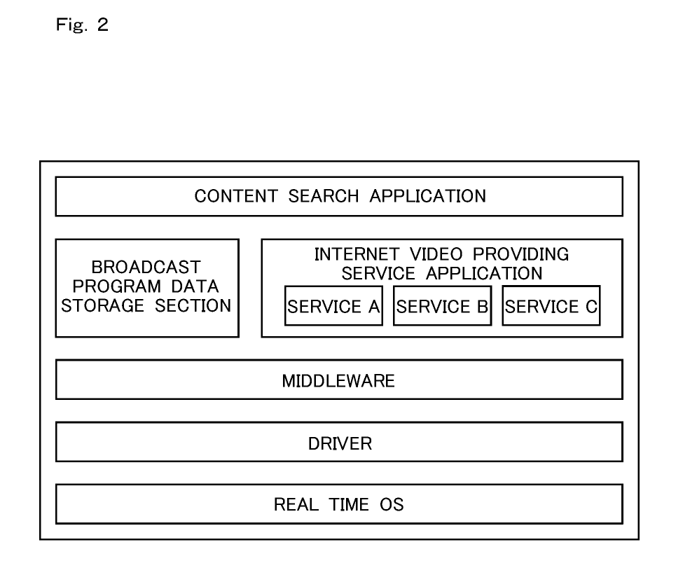

Next, FIG. 2 illustrates a software configuration example of the digital television receiver according to the embodiment of the present invention.

A driver is installed on a real time OS layer, and middleware is installed on a driver layer. Further installed on a middleware layer are a plurality of Internet video providing service applications. The Internet video providing service applications are configured independently of each other on a service basis.

Further, the transport stream generated by the tuner 1 is analyzed by the middleware, and service information (SI) data obtained from analysis results thereof is accumulated in a broadcast program data storage section. The SI data relates to program information used for structuring electronic program guide (EPG) or the like.

A content search application is installed on a multiple Internet video providing service applications layer and a broadcast program data storage section layer. The content search application realizes a collective search for the Internet content provided by each of the services corresponding to the plurality of Internet video providing service applications installed in the digital television receiver according to the embodiment of the present invention and the broadcast programs whose program information is included in the SI data accumulated in the broadcast program data storage section. The content search application can execute the above-mentioned collective search without starting up the plurality of the Internet video providing service applications.

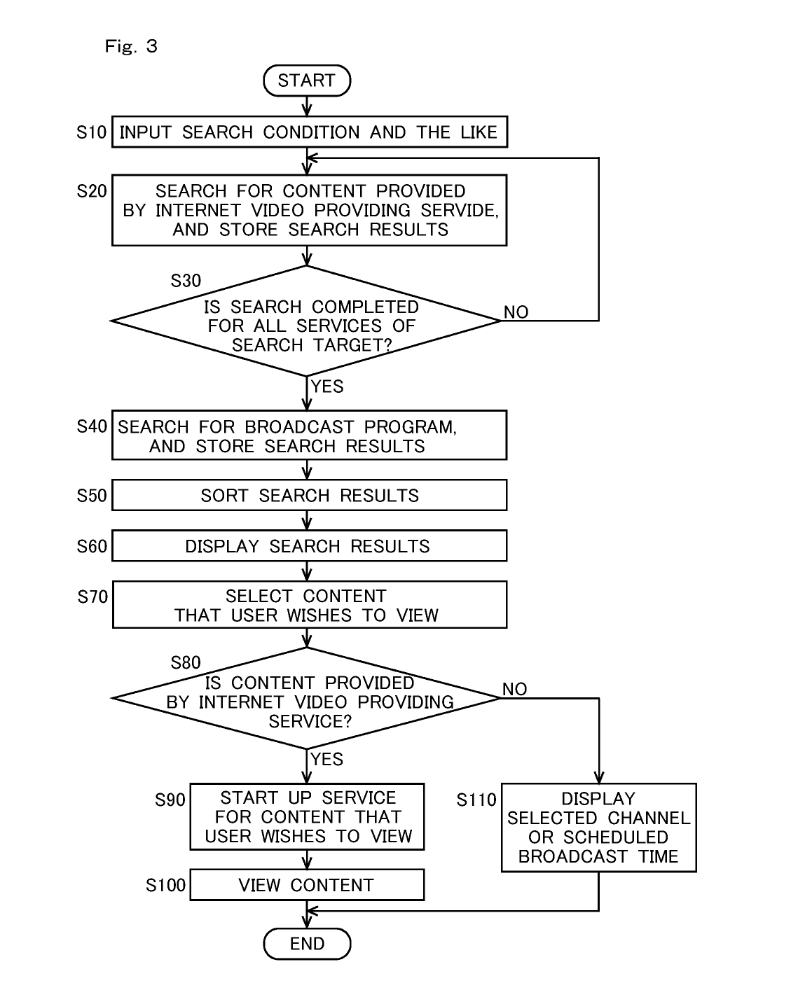

Next, an operation regarding the search for the digital content is described with reference to a flowchart illustrated in FIG. 3.

When the user performs a predetermined operation with respect to the key of the remote control 16 or the operation button of the input section 6, the content search application is started up, and the operation of the flowchart illustrated in FIG. 3 is started.

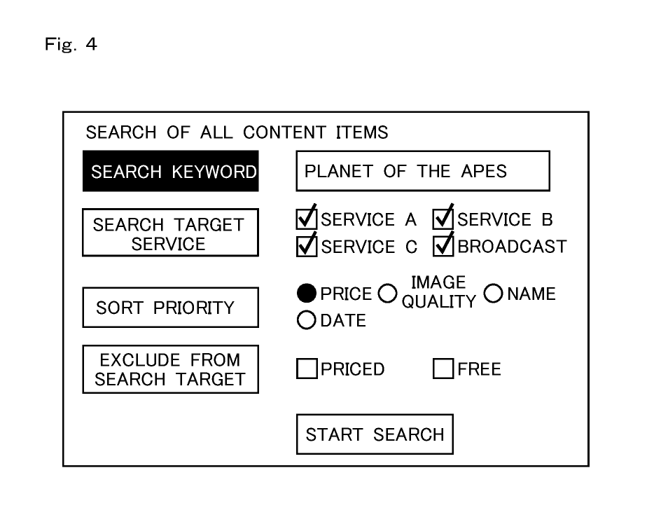

First, the main CPU 10 causes the display device 13 to display thereon such a menu screen as illustrated in FIG. 4 by an OSD function (Step S10). The user references the menu screen to operate the key of the remote control 16 or the operation button of the input section 6. Respective settings that are input by the above-mentioned operation include a search keyword, a service of a search target, a sort priority for search results, and a category of content excluded from the search target. In the example of FIG. 4, the search keyword has a format that allows an input of an arbitrary character string, but may have a format for selecting an item from genres of the content or predetermined keywords or other such format. Further, the sort priority for search results enables a combination of a plurality of priorities, and may have a format that allows a refined search of the search results. Further, the sort priority for search results may have a format that allows a selection made in an ascending order/descending order (for example, ascending order/descending order of price, ascending order/descending order of image quality or resolution, or ascending order/descending order of date).

When the user operates the key of the remote control 16 or the operation button of the input section 6 to thereby select “Start search” on such a menu screen as illustrated in FIG. 4 and when the selection is executed, the main CPU 10 executes a search for Internet content for the Internet video providing services of the search target one by one according to a search condition defined by the respective settings including the search keyword, the service of the search target, and the category of content excluded from the search target, and accumulates the search results in the RAM 9 (Steps S20 and S30).

When the search is completed for all the Internet video providing services of the search target (YES in Step S30), the main CPU 10 executes a search for the broadcast programs whose program information is included in the SI data accumulated in the broadcast program data storage section, and accumulates the search results in the RAM 9 (Step S40). After that, the procedure advances to Step S50. However, in a case where a broadcast program is not the search target according to the settings of the service of the search target, when the search is completed for all the Internet video providing services of the search target (YES in Step S30), the procedure immediately advances to Step S50 without the execution of the processing of Step S40.

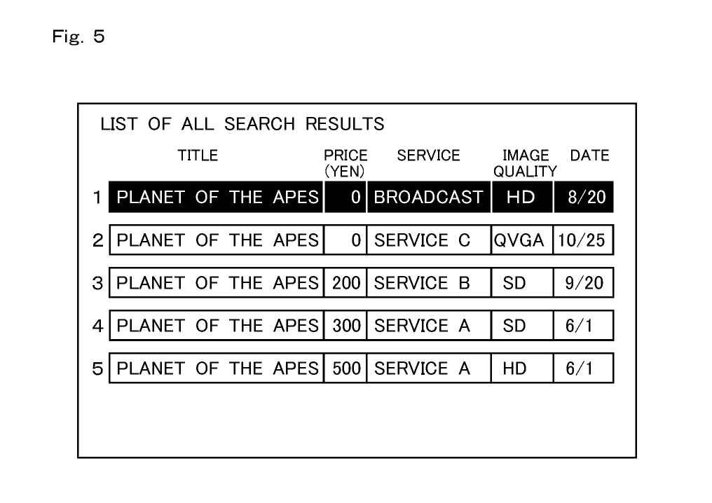

In Step S50, the main CPU 10 executes sorting of the search results according to the settings of the sort priority for search results by setting all the search results accumulated in the RAM 9 as a target. In Step S60 following Step S50, the main CPU 10 causes the display device 13 to display thereon the sorted search results in such a format as illustrated in FIG. 5. In other words, the main CPU 10 generates a display signal for collectively displaying the sorted search results in a list, and outputs the display signal to the display device 13.

Note that, in FIG. 5, the field “date” represents a date at which the content was uploaded onto the Internet video providing service for Internet content and a broadcast data for a broadcast program. The content provided by the Internet video providing service generally has a VOD format but may include a broadcast format. If the content provided by the Internet video providing service is content provided in a broadcast format, the “date” of FIG. 5 may be set as a day on which the content is to be broadcast by the Internet video providing service.

Further, in FIG. 5, the field “price (yen)” represents a viewing fee charged on each item of content when the content is viewed, and does not include a basic subscription fee (for example, monthly fee) required to enable the use of the Internet video providing service or the reception of a broadcast.

In Step S70 following Step S60, the user operates the key of the remote control 16 or the operation button of the input section 6 to thereby select such a given element (a given content item in a search result list) as illustrated in FIG. 5 on a search result list screen, and the selection is executed. In Step S80 following Step S70, the main CPU 10 determines whether or not the selected content item is provided by the Internet video providing service.

If the selected content item is provided by the Internet video providing service (YES in Step S80), the main CPU 10 starts up the Internet video providing service application corresponding to the Internet video providing service providing the selected content item (Step S90), and ends the content search application. Thereby, the display screen of the display device 13 changes to a viewing screen for the content item or a purchase screen for the content item, and then the user is allowed to view the selected content item (Step S100).

If the selected content item is a broadcast program instead of content provided by the Internet video providing service (NO in Step S80), the main CPU 10 controls the tuner 1 to set a channel corresponding to the broadcast program as a selected channel in the case of a currently-aired broadcast program, while causing the display device 13 to display thereon a scheduled broadcast time if the selected content item is not the currently-aired broadcast program (Step S110), and ends the content search application.

Note that, when the digital television receiver according to the embodiment of the present invention illustrated in FIG. 1 has a recording schedule function or a viewing schedule function, if the selected content item is not the currently-aired broadcast program, in Step S110, the main CPU 10 may perform a scheduling operation in addition to or instead of the displaying of the scheduled broadcast time on the display device 13.

By such an operation regarding the search for digital content as described above, a search for the digital content is performed across a plurality of Internet video providing services, and the search results are displayed. Accordingly, it is possible to aid the user to rationally select digital content that the user wishes to view. The effect can contribute to the improvement of convenience of the whole Internet video providing services.

The embodiment of the present invention has been described above, but the scope of the present invention is not limited thereto, and various changes can be made to the implementation thereof without departing from the gist of the invention.

The television broadcast receiving function or the function of displaying content or search results is not essential to the present invention. Therefore, the present invention can be applied to an STB and the like that do not have a display device or a speaker. If the present invention is applied to the digital content reproduction apparatus that does not have the television broadcast receiving function, it is natural that the processing corresponding to Step S40 of FIG. 3 be not carried out. Further, if the present invention is applied to the digital content reproduction apparatus that does not have the function of displaying content or search results, a content reproduction signal and a display signal for displaying search results and the like are externally output from the digital content reproduction apparatus.

What is claimed is:

1. A digital content reproduction apparatus, which has an Internet connection function, comprising:
a search condition input section which receives an input of a search condition;
a search execution section which executes a search according to the search condition input through the search condition input section by setting digital content provided by a plurality of Internet video providing services as a search target; and
a display signal generation section which generates a display signal for collectively displaying results of the search executed by the search execution section in a list.

2. A digital content reproduction apparatus according to claim 1, wherein:
the digital content reproduction apparatus has a television broadcast receiving function; and
the search execution section also sets digital content provided through a television broadcast wave as the search target.

3. A digital content reproduction apparatus according to claim 1, wherein the display signal comprises a signal for collectively displaying the results of the search executed by the search execution section in the list after sorting the results in one of an ascending order and a descending order of viewing fee that is an attribute of the digital content.

4. A digital content reproduction apparatus according to claim 1, wherein the display signal comprises a signal for collectively displaying the results of the search executed by the search execution section in the list after sorting the results in one of an ascending order and a descending order of resolution that is an attribute of the digital content.

5. A digital content reproduction apparatus according to claim 1, wherein the display signal comprises a signal for collectively displaying the results of the search executed by the search execution section in the list after sorting the results in one of an ascending order and a descending order of date that is an attribute of the digital content.
